(19) United States
(12) Patent Application Publication
(10) Pub. No.: US 2024/0221005 A1
(43) Pub. Date: Jul. 4, 2024

(54) ENVIRONMENTAL IMPACT ESTIMATION APPARATUS, ENVIRONMENTAL IMPACT ESTIMATION METHOD AND PROGRAM

(71) Applicant: NIPPON TELEGRAPH AND TELEPHONE CORPORATION, Tokyo (JP)

(72) Inventors: Helen STEWART, Tokyo (JP); Takashi FURUTANI, Tokyo (JP); Akira TAKEUCHI, Tokyo (JP); Yuriko TANAKA, Tokyo (JP)

(21) Appl. No.: 18/558,273

(22) PCT Filed: May 19, 2021
(86) PCT No.: PCT/JP2021/019002

§ 371 Date: Oct. 31, 2023

(51) Int. Cl. G06Q 30/0201

(52) U.S. Cl. CPC G06Q 30/0201

(57) ABSTRACT

An environmental load estimation device that estimates an environmental load of a food includes a food consumption weight estimation unit that estimates a consumption weight of the food by using sales data of the food and price data of the food, and an environmental load estimation unit that estimates the environmental load of the food by using the consumption weight estimated by the food consumption weight estimation unit and an environmental load coefficient of the food.

### TECHNICAL FIELD

The present invention relates to a technology for estimating an environmental load caused by food.

### BACKGROUND ART

First, the background art will be described. Documents to be referred to in the present specification below are denoted by “[1]” or the like, and corresponding document names are collectively described at the end.

As of 2019, global food supply chains emitted approximately 13.7 billion metric tons of carbon dioxide equivalent, accounting for 26% of human-derived greenhouse gas emissions. Food supply chains are very resource intensive, covering about 43% of the land without ice and desert [1] (Non Patent Literature 1).

It is estimated that the world's food production also uses the most water in the world, with ⅔ of the current fresh water intake being used for agricultural irrigation [1,2]. Global carbon dioxide emissions must begin to decrease significantly by 2030 in order to keep global warming below 1.5° C.

It is expected that climate change will affect the quality and quantity of food produced in the world and the ability of distributors to distribute the food. Food systems continue to face increasing pressure in the future due to global population growth. However, due to limited resources, constraints on the ability to provide new land, fisheries, and fresh water to meet increasing demand are faced [4,5]. Modern agriculture leads to environmental degradation through eutrophication, acidification, and soil degradation [6]. In order to develop a global food system in a sustainable manner, it is necessary to consider and manage the influence of agriculture on environmental degradation and global warming. Therefore, it is important to estimate an environmental load of food.

### CITATION LIST

### Non Patent Literature

Non Patent Literature 1: Poore, Joseph, and Thomas Nemecek. “Reducing food's environmental impacts through producers and consumers.” Science 360.6392 (2018): 987-992.

### SUMMARY OF INVENTION

### Technical Problem

However, the estimation of the environmental load of food according to the related art is not based on actual consumption data of food, but is based on an estimated value of a fixed consumption amount. For example, as the estimated value of the consumption amount, data obtained from the nutritional requirements [7], the dietary guidelines [8], the national food supply data [9], or the FAOSTAT statistical database is used. These databases or guidelines are updated less than once a year and do not reflect changes in consumption patterns based on changes in seasons, natural disasters, pandemics, and social trends.

Therefore, the accuracy of estimating the environmental load of food according to the related art is insufficient for daily tracking of changes occurring in society and food systems. Its accuracy is also insufficient to track climate change mitigation and progress towards the net 0 emissions target of 2050.

The present invention has been made in view of the above circumstances, and an object of the present invention is to provide a technology capable of estimating an environmental load of food in which actual consumption data is reflected at a time interval shorter than that in the related art.

### Solution to Problem

According to the disclosed technology, there is provided an environmental load estimation device that estimates an environmental load of food, the environmental load estimation device including:

a food consumption weight estimation unit that estimates a consumption weight of the food by using sales data of the food and price data of the food; and an environmental load estimation unit that estimates the environmental load of the food by using the consumption weight estimated by the food consumption weight estimation unit and an environmental load coefficient of the food.

### Advantageous Effects of Invention

According to the disclosed technology, it is possible to estimate an environmental load of food in which actual consumption data is reflected at a time interval shorter than that in the related art.

### BRIEF DESCRIPTION OF DRAWINGS

FIG. 1 is a diagram for describing environmental load estimation in the related art.

FIG. 2 is a diagram illustrating an outline of an embodiment of the present invention.

FIG. 3 is a configuration diagram of an environmental load estimation device 100.

FIG. 4 is a diagram illustrating an example of data in a meta-analysis DB 130.

FIG. 5 is a flowchart of a process of the environmental load estimation device 100.

FIG. 6 is a diagram illustrating a hardware configuration example of the device.

### DESCRIPTION OF EMBODIMENTS

Hereinafter, an embodiment of the present invention (present embodiment) will be described with reference to the drawings. The embodiment described below is only an example, and an embodiment to which the present invention is applied is not limited to the following embodiment.

### (Environmental Load of Food System)

First, an environmental load of a food system targeted in the present embodiment will be described. The “food system” may be referred to as a “dietary system”. The “environmental load of the food system” may be referred to as an “environmental load of food”.

With respect to the environmental load of the food system, studies using various environmental load indexes based on life cycle assessment (LCA) such as energy consumption, land use, water intake, fertilizer use, greenhouse gas (GHG) discharge, ozone generation, eutrophication, human toxicity, acidification of land, particulate matter, ecotoxicity, and water quality destruction have been conducted in various regions [11 to 14].

When an environmental load of specific food is calculated, data of environmental indexes are aggregated and statistically analyzed on the basis of a plurality of scientific investigations. This process is called meta-analysis. The meta-analysis is an important tool for environmental load assessment because the meta-analysis allows insight into variations between production methods in different regions.

However, since preconditions or methods of the study are subjective, there is a possibility that an estimated value of the environmental load varies. The estimated value of the environmental load in the meta-analysis is indicated with uncertainty because the estimated value reflects this variation.

In 2019, Poore and Nemecek published a comprehensive meta-analysis study on the environmental load of food systems [1]. This study summarizes the environmental load data from 38,700 farms and 1600 processors in 119 countries. The document [1] is the largest meta-analysis study published on food systems.

The environmental load indexes used in this meta-analysis are: GHG emissions (in kg CO₂ equivalent), land use (m² year), acidification (in gSO₂ equivalent), eutrophication (in gPO₄³⁻ equivalent), and scarcity-weighted water intake (in kL equivalent). The meta-analysis data obtained from this study is publicly available. This data is geographically and statistically extensive, and is thus a suitable source of data for estimating an environmental load related to food consumption in Japan.

### (Outline of Present Embodiment)

Next, an outline of the present embodiment will be described. In the present embodiment, an environmental load estimation device 100 that will be described later estimates an environmental load of food at a time interval shorter than that in the related art.

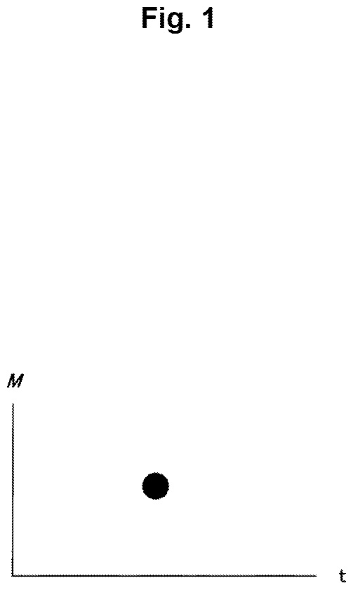

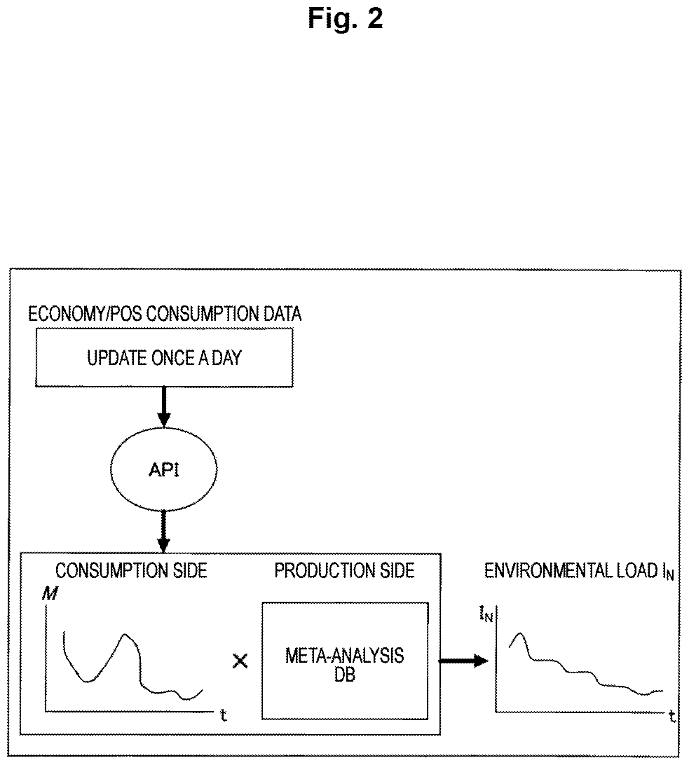

For comparison, FIG. 1 illustrates an outline of the environmental load estimation method according to the related art, and FIG. 2 illustrates an outline of an environmental load estimation method according to the present embodiment. In FIGS. 1 and 2, M indicates a consumption weight of food, and I indicates an environmental load of a certain index.

In the environmental load estimation of food according to the related art, national government survey data is used. FIG. 1 illustrates an image thereof. The update frequency is less than or equal to once a year, and as a result, a time resolution of the environmental load estimated value is less than or equal to once a year. In the related art, there is a delay of several years until the data is released.

The national government survey data is based on food supply data, and data of actual food consumption is limited. It is difficult to understand the influence of climate change, disasters, and the like on consumption.

On the other hand, in the environmental load estimation method according to the present embodiment, as illustrated in FIG. 2, POS data indicating the total sales of foods and food price data updated about once a week are used to estimate the total weight of food consumed in a day (food consumption weight M).

Next, as in DB [1] created by Poore and Nemecek, an environmental load with respect to a given food consumption weight is estimated by using a meta-analysis DB indicating environmental load statistics in units of weight of various food groups. A specific estimation method will be described later.

According to the environmental load estimation method in the present embodiment, environmental load indexes such as land use, greenhouse gas emissions, and water intake can be calculated with high reliability at short time intervals.

Understanding the environmental load due to current consumption patterns becomes increasingly important for sustainable development. Also, understanding land use for food products around the world allows calculating sustainable consumption patterns based on available resources.

For example, if food systems are tried to be localized in the future, a sustainable consumption pattern in Japan with limited land but rich water will be different from a sustainable consumption pattern in Australia with abundant land but limited water.

Population growth projections can also be used to predict whether current consumption patterns are sustainable within the limited resources of the Earth. For example, the consumption of a food group with the highest environmental load can be specified and replaced with a more sustainable alternative that is nutritionally equivalent. The real-time calculation of the environmental load provides a policy planner with a tool for evaluating a progress status toward an environmental load reduction target for climate change mitigation.

### EXAMPLE

Hereinafter, a configuration and an operation of the environmental load estimation device 100 will be described in detail as an example.

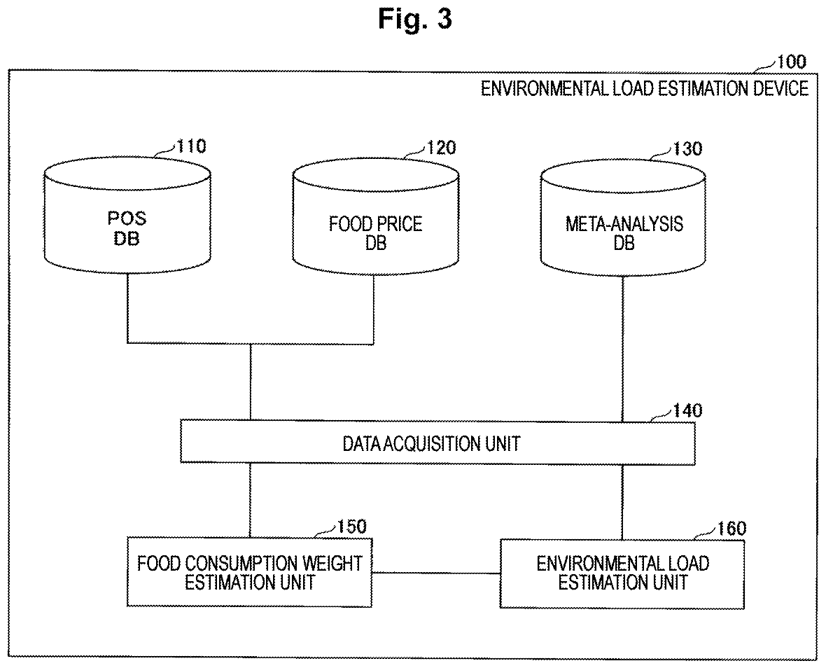

FIG. 3 illustrates a configuration diagram of the environmental load estimation device 100 in the present embodiment. As illustrated in FIG. 3, the environmental load estimation device 100 includes a POS-database (DB) 110, a food price DB 120, a meta-analysis DB 130, a data acquisition unit 140, a food consumption weight estimation unit 150, and an environmental load estimation unit 160.

The environmental load estimation device 100 may include one device (computer) or a plurality of devices. The environmental load estimation device 100 may be provided on a cloud. Each of the POS-database (DB) 110, the food price DB 120, and the meta-analysis DB 130 may be outside the environmental load estimation device 100. Each of the units will be described below.

### <Pos-db 110>

The POS-DB 110 stores POS data acquired from the outside. Alternatively, the POS-DB 110 may be a DB of a POS service provider described below provided outside the environmental load estimation device 100.

Information regarding daily sales of goods and the like are stored in the POS-DB 110. The data of the POS-DB 110 may be any POS data as long as it is data from which it is possible to obtain information regarding daily sales of goods, and in the present embodiment, as an example, data provided by the “real shopper SM” service of the Shopper Insight is used. The “real shopper SM” service allows obtaining daily sales data (POS data) of fresh food without a JAN code, such as fresh meat, fish, fruits, or vegetables.

By using a weight equivalent coefficient that converts a weight of processed food into an equivalent weight of fresh food, it is also possible to extend the environmental load estimation for the fresh food to the processed food.

### <Meta-Analysis DB 130>

The document [1] discloses environmental load data of 40 food groups based on greenhouse gas (GHG) emissions (in kgCO₂ equivalent), land use (m² year), acidification (in gSO₂ equivalent), eutrophication (in gPO₄³⁻ equivalent), and scarcity-weighted water intake (in kL equivalent). The meta-analysis DB 130 stores data based on the document [1].

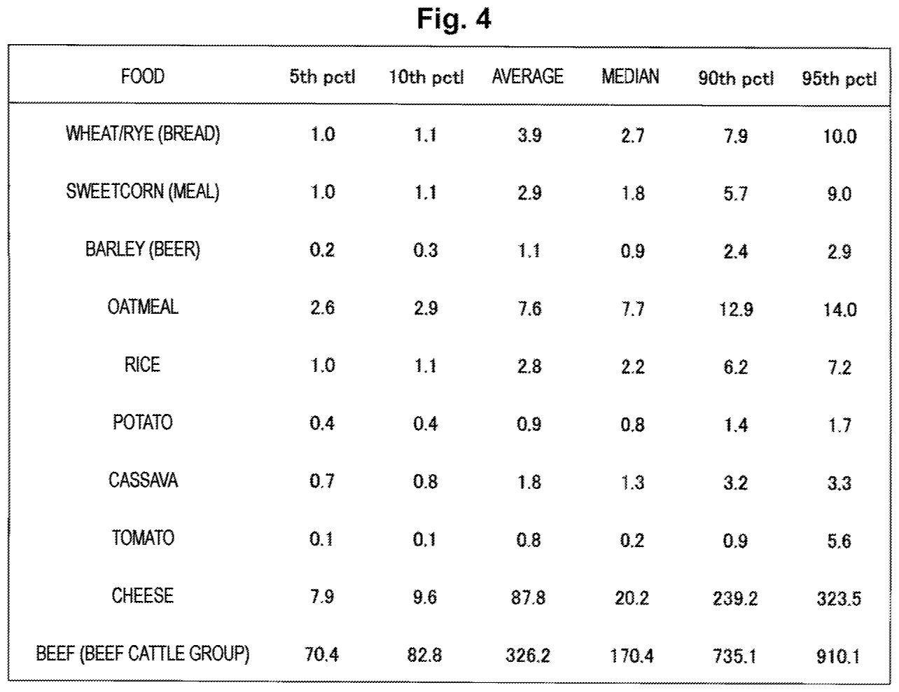

FIG. 4 illustrates an example of data disclosed in the document [1], that is, data stored in the meta-analysis DB 130. The data illustrated in FIG. 4 shows samples of statistical factors for land use for different food groups, defined as production area multiplied by years of occupancy (m² year). The coefficient will be referred to as an environmental load coefficient.

More specifically, the data illustrated in FIG. 4 is samples of land use data for 10 food groups out of the 40 food groups. The value is expressed in m²/functional unit and the functional unit is 1 kg of the edible crop.

### <Food Price DB 120>

In the food price DB 120, for example, data of food prices disclosed by the Ministry of Agriculture, Forestry and Fisheries is stored. The data in the food price DB 120 is updated every week (once a week), for example.

### <Data Acquisition Unit 140>

The data acquisition unit 140 corresponds to the API illustrated in FIG. 2. The data acquisition unit 140 acquires POS data from POS-DB 110, acquires data of a food price from the food price DB 120, and passes the data to the food consumption weight estimation unit 150.

The data acquisition unit 140 acquires an environmental load coefficient from the meta-analysis DB 130, and passes the acquired environmental load coefficient to the environmental load estimation unit 160.

### <Food Consumption Weight Estimation Unit 150>

The food consumption weight estimation unit 150 estimates a food consumption weight by using the POS data and the food price data. Specifically, the food consumption weight estimation unit 150 calculates a consumption weight Mₖ of a certain food group k according to the following Formula 1.

$${M}_{k} = s / pr \qquad ( Math 1 )$$

Here, s is total daily sales (total food sales) [yen] of a specific food group from the POS data ([15]), r is a market share of the POS data (1.8% in the Shopper Insight database), and p is a price of the food per kilogram [yen/kg]. The Ministry of Agriculture, Forestry and Fisheries in Japan publishes data regarding average food prices on a weekly basis [16], and this data is also used in the present example. The unit for the total sales obtained as the POS data is one day as an example, and may be, for example, one hour or one week.

### <Environmental Load Estimation Unit 160>

The environmental load estimation unit 160 calculates an estimated value of the environmental load of a food with a certain weight by using the food consumption weight estimated by the food consumption weight estimation unit 150 and the environmental load coefficient acquired from the meta-analysis DB 130.

Specifically, the environmental load estimation unit 160 calculates a total amount of the environmental load per day in all K food groups with respect to an index Iₙ, of the environmental load according to the following Formula 2. A calculation period in units of one day is an example, and may be shorter than one day.

$${I}_{n} = {\sum }_{k}^{K} = {}_{0} {C}_{n\_k} {M}_{k} \qquad ( Math 2 )$$

Here, C_{n_k} is an environmental load coefficient of the index n of the food group k, and Mₖ is a weight of food of the food group k consumed on a certain day.

The consumption weights of tomato, cheese, and beef on a certain day are 500t, 80t, and 200t, respectively. By using the data in FIG. 4, the medians of land use of tomato (L_{tom_med}), cheese (L_{cheese_med}), and beef (L_{beef_med}) corresponding to the consumption weights are calculated as follows.

$$\begin{matrix}{L}_{tom\_med} = 0.2 \times 500 \times {10}^{3} = 0.1 \times {10}^{6} [ {m}^{2} year ] \\ {L}_{cheese\_med} = 20.2 \times 80 \times {10}^{3} = 1.6 \times {10}^{6} [ {m}^{2} year ] \\ {L}_{beef\_med} = 170.4 \times 200 \times {10}^{3} = 34 \times {10}^{6} [ {m}^{2} year ]\end{matrix}$$

As described below, a range of land use can be calculated with a 90% reliability section using a range between a 5 percentile value and a 95 percentile value.

$$\begin{matrix}{L}_{tom} = ( 0.1 ∼ 2.8 ) \times {10}^{6} [ {m}^{2} year ] ( 90 \% reliability ) \\ {L}_{cheese} = ( 0.6 ∼ 25.9 ) \times {10}^{6} [ {m}^{2} year ] ( 90 \% reliability ) \\ {L}_{beef} = ( 10. ∼ 182. ) \times {10}^{6} [ {m}^{2} year ] ( 90 \% reliability ) .\end{matrix}$$

By summing the environmental load estimated values for the land use as described above for all the food groups in the DB, it is possible to estimate the environmental load for the land use based on the daily consumption of the entire fresh food. By summing the environmental load of the daily land use over one year, it is possible to estimate the annual land use linked to the food consumption.

According to the environmental load estimation method in the present embodiment, an actual consumption pattern can be reflected and the food waste can also be incorporated, so that the environmental load can be estimated more accurately than the conventional method [8] using the estimation of the calorie consumption per person.

In the present embodiment, fresh food is targeted, but as described above, an environmental load of processed food may also be estimated by using a weight conversion factor.

### <Operation Flow>

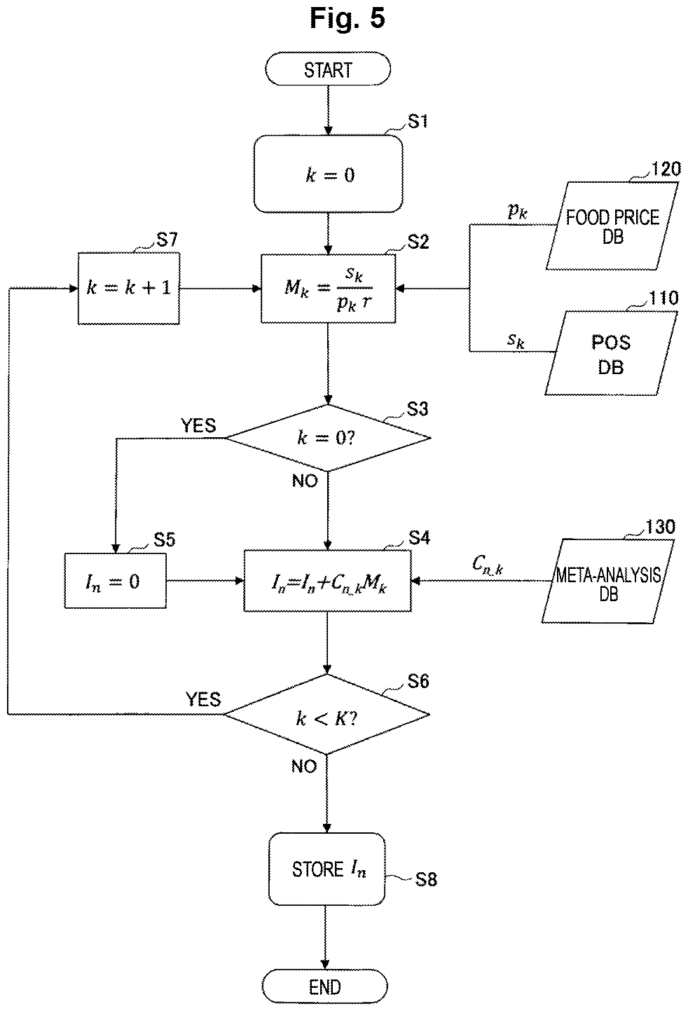

With reference to a flowchart of FIG. 5, an operation procedure of the environmental load estimation device 100 when calculating an environmental load for a certain index In by using Formulas 1 and 2 will be described.

In S1, the food consumption weight estimation unit 150 initializes k (index of food group) to 0. In S2, the food consumption weight estimation unit 150 acquires total sales data sₖ for the food group k from the POS-DB 110, acquires food price data pₖ from the food price DB 120, and calculates a food consumption weight Mₖ according to Formula 1. The calculated Mₖ is passed to the environmental load estimation unit 160.

If k=0, Iₙ=0, and the process proceeds to S4 (Yes in S3; S5). In S4, the environmental load estimation unit 160 acquires the environmental load coefficient C_{n_k} from the meta-analysis DB 130, and updates Iₙ with Iₙ=Iₙ+C_{n_k}Mₖ on the basis of Formula 2.

While k is incremented by 1, the above process is repeatedly performed until k reaches K (S6 and S7), and in S8, an estimated value of the environmental load in all the K food groups is obtained. The environmental load estimation unit 160 may store the estimated value of the environmental load in a storage device or may output the estimated value to the outside.

### (Hardware Configuration Example)

The environmental load estimation device 100 can be implemented by, for example, causing a computer to execute a program. This computer may be a physical computer, or may be a virtual machine on a cloud.

In other words, the environmental load estimation device 100 can be implemented by executing a program corresponding to the processes performed in the environmental load estimation device 100 by using hardware resources such as a CPU or memory built into the computer. The program can be stored and distributed by being recorded in a computer-readable recording medium (a portable memory or the like). The program can be provided via a network such as the Internet or an electronic mail.

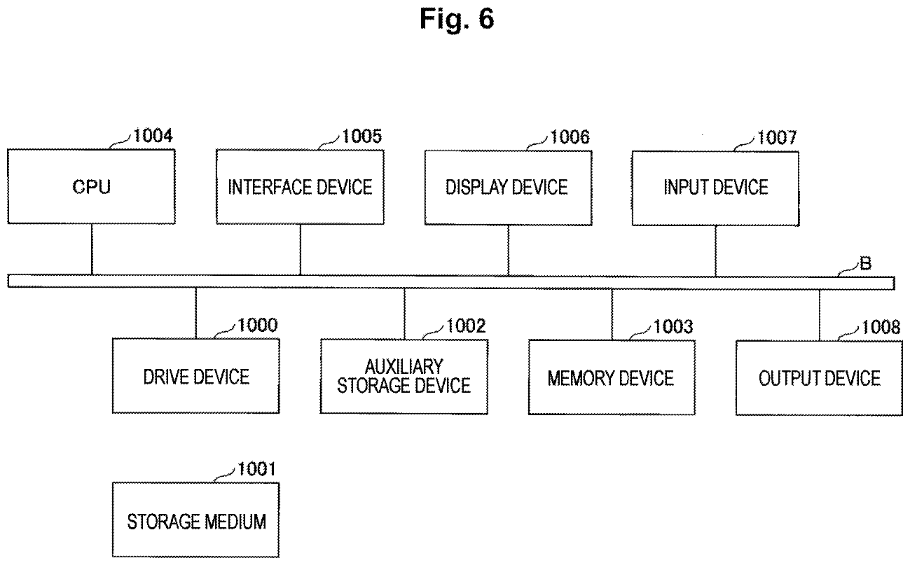

FIG. 6 is a diagram illustrating a hardware configuration example of the computer. The computer in FIG. 6 includes a drive device 1000, an auxiliary storage device 1002, a memory device 1003, a CPU 1004, an interface device 1005, a display device 1006, an input device 1007, an output device 1008, and the like which are connected to each other via a bus BS. Some of these devices are not necessarily included. For example, in a case where display is not to be performed, the display device 1006 may not be included.

The program for realizing the processes in the computer is provided by, for example, a recording medium 1001 such as a CD-ROM or a memory card. When the recording medium 1001 that stores the program is set in the drive device 1000, the program is installed from the recording medium 1001 into the auxiliary storage device 1002 via the drive device 1000. Here, the program is not necessarily installed from the recording medium 1001, and may be downloaded from another computer via a network. The auxiliary storage device 1002 stores the installed program, and also stores necessary files, data, and the like.

In a case where an instruction for starting the program is input, the memory device 1003 reads the program from the auxiliary storage device 1002, and stores the program therein. The CPU 1004 realizes functions related to a corresponding device according to the program stored in the memory device 1003. The interface device 1005 is used as an interface for connecting to a network. The display device 1006 displays a graphical user interface (GUI) or the like according to the program. The input device 1007 includes a keyboard and a mouse, buttons, a touch panel, and the like, and is used to input various operation instructions. The output device 1008 outputs a calculation result.

### Effects of Embodiment

As described above, the environmental load estimation device 100 according to the present embodiment can estimate an environmental load of food in which actual consumption data is reflected at a time interval shorter than that in the related art. Specifically, this is as follows.

Since the time accuracy of the environmental load estimation is improved from once a year to once a day by the environmental load estimation device 100 according to the present embodiment, it is possible to ascertain dynamic changes in an environmental load of food.

The environmental load estimation device 100 according to the present embodiment can estimate an environmental load by reflecting changes in consumption by using indexes of the environmental load such as annual land use, greenhouse gas emissions, acidification, eutrophication, and scarcity-weighted water intake.

Although the conventional method for estimating an environmental load takes a very long time, according to the technology of the present embodiment, it is possible to automatically perform the environmental load estimation in real time. Estimating the environmental load of food in real time is a valuable tool for policy planners to manage their progress toward environmental load reduction targets. It is also possible to specify sustainable consumption patterns on the basis of resources available in various regions.

### Summary of Embodiment

The present specification discloses at least an environmental load estimation device, an environmental load estimation method, and a program in the following appendixes.

### (Appendix 1)

An environmental load estimation device that estimates an environmental load of food, the environmental load estimation device including:
a food consumption weight estimation unit that estimates a consumption weight of the food by using sales data of the food and price data of the food; and
an environmental load estimation unit that estimates the environmental load of the food by using the consumption weight estimated by the food consumption weight estimation unit and an environmental load coefficient of the food.

### (Appendix 2)

The environmental load estimation device according to Appendix 1, in which
the environmental load estimation unit acquires the environmental load coefficient from a meta-analysis database that stores an environmental load coefficient obtained through meta-analysis for each food.

### (Appendix 3)

The environmental load estimation device according to Appendix 1 or 2, in which
the food consumption weight estimation unit acquires the sales data from a database that stores POS data.

### (Appendix 4)

The environmental load estimation device according to any one of Appendixes 1 to 3, in which
the environmental load estimation unit adds a value obtained by multiplying a consumption weight by the environmental load coefficient to a plurality of foods to calculate a total amount of environmental loads of a plurality of foods.

### (Appendix 5)

An environmental load estimation method executed by an environmental load estimation device that estimates an environmental load of food, the method including:
a food consumption weight estimation step of estimating a consumption weight of the food by using sales data of the food and price data of the food; and
an environmental load estimation step of estimating the environmental load of the food by using the consumption weight estimated in the food consumption weight estimation step and an environmental load coefficient of the food.

### (Appendix 6)

A program for causing a computer to function as each unit of the environmental load estimation device according to any one of Appendixes 1 to 4.

Although the present embodiment has been described above, the present invention is not limited to such a specific embodiment, and various modifications and changes can be made within the scope of the spirit of the present invention described in the claims.

### REFERENCE DOCUMENTS

[1] Poore, Joseph, and Thomas Nemecek. “Reducing food's environmental impacts through producers and consumers.” Science 360.6392 (2018): 987-992.
[2] Tilman, David, et al. “Agricultural sustainability and intensive production practices.” Nature 418.6898 (2002): 671-677.
[3] IPCC, 2018: Summary for Policymakers. In: Global Warming of 1.5° C.
   https://www.ipcc.ch/site/assets/uploads/sites/2/2019/05/SR1 5_SPM_version_report_LR.pdf.
[4] Grafton, R. Quentin, John Williams, and Qiang Jiang. “Food and water gaps to 2050: preliminary results from the global food and water system (GFWS) platform.” Food Security 7.2 (2015): 209-220.
[5] Myers, Samuel S., et al. “Climate change and global food systems: potential impacts on food security and undernutrition.” Annual review of public health 38.1 (2017): 259-277.
[6] Rickson, R. J., et al. “Input constraints to food production: the impact of soil degradation.” Food security 7.2 (2015): 351-364.
[7]P Hawken et al. (2017). “Project Drawdown: Table of Solutions.” https://www.drawdown.org/solutions/table-of-solutions
[8] Rizvi, Sarah, et al. “Global land use implications of dietary trends.” Plos one 13.8 (2018): e0200781.
[9] Sandstrom, Vilma, et al. “The role of trade in the greenhouse gas footprints of EU diets.” Global food security 19 (2018): 48-55.
[10] Food and Agriculture Organization of the United Nations. FAOSTAT Statistical Database. [Rome]:FAO, 1997.
[11] Cuellar, Amanda D., and Michael E. Webber. “Wasted food, wasted energy: the embedded energy in food waste in the United States.” Environmental science & technology 44.16 (2010): 6464-6469.
[12] Birney, Catherine I., et al. “An assessment of individual foodprints attributed to diets and food waste in the United States.” Environmental Research Letters 12.10 (2017): 105008.
[13] Tonini, Davide, Paola Federica Albizzati, and Thomas Fruergaard Astrup. “Environmental impacts of food waste: Learnings and challenges from a case study on UK.” Waste Management 76 (2018): 744-766.
[14] Scherhaufer, Silvia, et al. “Environmental impacts of food waste in Europe.” Waste management 77 (2018): 98-113.
[15] Shopper Insight (2021). Real Shopper SM. http://shopperinsight.co.jp/service/.
[16] Ministry of Agriculture, Forestry and Fisheries (2019). “Food price trend survey”. https://www.maff.go.jp/j/zyukyu/anpo/kouri/k_yasai/h22index.html

### REFERENCE SIGNS LIST

100 Environmental load estimation device
110 POS-DB (database)
120 Food price DB
130 Meta-analysis DB
140 Data acquisition unit
150 Food consumption weight estimation unit
160 Environmental load estimation unit
1000 Drive device
1001 Recording medium
1002 Auxiliary storage device
1003 Memory device
1004 CPU
1005 Interface device
1006 Display device
1007 Input unit

1. An environmental load estimation device that estimates an environmental load of food, the environmental load estimation device comprising:
a processor; and
a memory storing program instructions that cause the processor to:
estimate a consumption weight of the food by using sales data of the food and price data of the food; and
estimate the environmental load of the food by using the estimated consumption weight and an environmental load coefficient of the food.

2. The environmental load estimation device according to claim 1, wherein
the program instructions cause the processor to acquire the environmental load coefficient from a meta-analysis database that stores an environmental load coefficient obtained through meta-analysis for each food.

3. The environmental load estimation device according to claim 1, wherein
the program instructions cause the processor to acquire the sales data from a database that stores POS data.

4. The environmental load estimation device according to claim 1, wherein
the program instructions cause the processor to add a value obtained by multiplying a consumption weight by the environmental load coefficient to a plurality of foods to calculate a total amount of environmental loads of a plurality of foods.

5. An environmental load estimation method executed by an environmental load estimation device that estimates an environmental load of food, the method comprising:
estimating a consumption weight of the food by using sales data of the food and price data of the food; and
estimating the environmental load of the food by using the estimated consumption weight and an environmental load coefficient of the food.

6. A non-transitory computer-readable recording medium storing a program for causing a computer to perform the environmental load estimation method of claim 5.
